(19) United States
(12) Patent Application Publication
(10) Pub. No.: US 2015/0078724 A1
(43) Pub. Date: Mar. 19, 2015

(54) REMOTE AUDIO RECORDING CAMERA SYSTEM

(71) Applicant: SENA TECHNOLOGIES INC., Seoul (KR)

(72) Inventor: Oh Jin Jung, Seoul (KR)

(73) Assignee: SENA TECHNOLOGIES INC., Seoul (KR)

(21) Appl. No.: 14/482,341

(22) Filed: Sep. 10, 2014

(30) Foreign Application Priority Data
Sep. 13, 2013 (KR) 10-2013-0110445

(51) Int. Cl. H04N 5/77; H04B 1/713; G11B 20/10

(52) U.S. Cl. CPC H04N 5/772; G11B 20/10527; H04B 1/713; G11B 2020/10546; H04B 2201/71346
USPC 386/224

(57) ABSTRACT

A remote audio recording camera system, which enables users to communicate with each other even when they are far from each other, and which synthesizes speech data of users to store the synthesized speech data in a Bluetooth camera. The remote audio recording camera system includes: at least one first Bluetooth headset configured to be worn by a first user; a second Bluetooth headset configured to be worn by a second user that communicates with the first user, and to synthesize speech data of the first user received by the first Bluetooth headset and speech data input from the second user by using a speech synthesizer to transmit the synthesized speech data; and a Bluetooth camera configured to include a speech storage that stores the synthesized speech data received from the second Bluetooth headset, and an image storage that stores captured images.

### CROSS-REFERENCE TO RELATED APPLICATION(S)

This application claims priority from Korean Patent Application No. 10-2013-0110445, filed on Sep. 13, 2013, in the Korean Intellectual Property Office, the entire disclosure of which is incorporated herein by reference for all purposes.

### BACKGROUND

1. Field

The following description relates to a camera system that provides remote audio recording by synthesizing speech data of users who are wearing Bluetooth headsets, and then transmitting the synthesized speech data to a Bluetooth camera to store the data in the camera.

2. Description of the Related Art

Generally, a camera is used to take photographs of a subject, but recently, beyond the function of taking still photographs, the camera includes various multimedia functions to film and store videos.

Photographs are usually taken by a user holding a camera in their hands, such that in a case where a user is at a distance from a subject while filming a video, a voice of the subject may not reach the camera, thus failing to be recorded.

In order to solve the problem, a Bluetooth camera with a Bluetooth module has been developed to receive and store speech from a subject wearing a Bluetooth microphone. However, in a conventional Bluetooth camera, speech of a subject is merely received and stored, but speech of a person filming a video is not transmitted to the subject, thereby leading to a difficulty in communication between a person filming a video and a subject to be filmed. Further, in a case where there is a plurality of subjects, there is a problem in that these subjects may not be able to communicate with each other.

### SUMMARY

The present disclosure provides a remote audio recording camera system, in which users may communicate with each other even when they are at a distance from each other, and speech data of users may be synthesized to be stored in a Bluetooth camera.

In one general aspect, there is provided a remote audio recording camera system, which includes: at least one first Bluetooth headset configured to be worn by a first user; a second Bluetooth headset configured to be worn by a second user that communicates with the first user, and to synthesize speech data of the first user received by the first Bluetooth headset and speech data input from the second user by using a speech synthesizer to transmit the synthesized speech data; and a Bluetooth camera configured to include a speech storage that stores the synthesized speech data received from the second Bluetooth headset, and an image storage that stores captured images.

### BRIEF DESCRIPTION OF THE DRAWINGS

FIG. 1 is a block diagram illustrating an example of a remote audio recording camera system according to an exemplary embodiment.

FIG. 2 is a block diagram illustrating a second Bluetooth headset in FIG. 1.

FIG. 3 is a block diagram illustrating another example of the remote audio recording camera system in FIG. 1.

FIG. 4 is a block diagram illustrating another example of the remote audio recording camera system in FIG. 3.

FIG. 5 is a block diagram illustrating another example of the remote audio recording camera system in FIG. 4.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

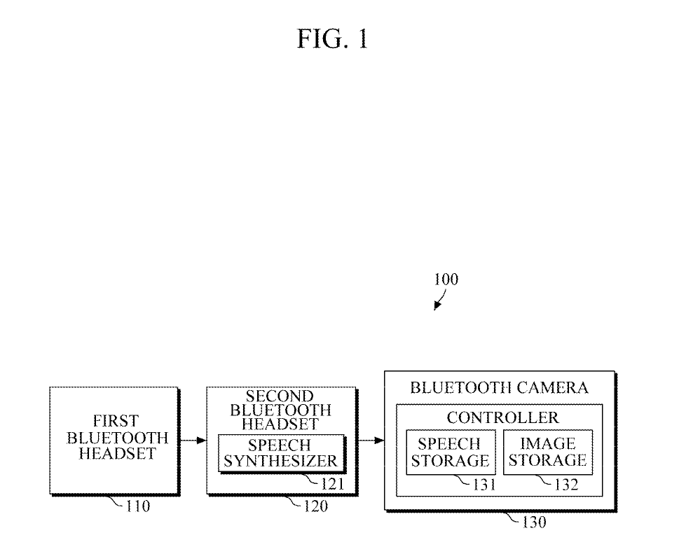

FIG. 1 is a block diagram illustrating an example of a remote audio recording camera system according to an exemplary embodiment. The remote audio recording camera system 100 according to the exemplary embodiment enables users to communicate with each other even when they are far from each other, and synthesizes speech data of users to store the synthesized speech data in a camera.

As illustrated in FIG. 1, the remote audio recording camera system 100 includes a first Bluetooth headset 110, a second Bluetooth headset 120, and a Bluetooth camera 130.

A first Bluetooth headset 110 is worn by a first user, and there may be one or more first Bluetooth headsets 110. The first user wearing the first Bluetooth headset 110 may be a subject to be filmed.

A second Bluetooth headset 120 is worn by a second user that communicates with the first user, and synthesizes speech data of the first user received by the first Bluetooth headset 110 and speech data input from the second user by using a speech synthesizer 121 to transmit the synthesized speech data.

The second user wearing the second Bluetooth headset 120 may be a person holding the Bluetooth camera 130, or may be a subject to be filmed. That is, the second user wearing the second Bluetooth headset 120 holds the Bluetooth camera 130 to film the first user, or may support the Bluetooth camera 130 on a support, such as a tripod, to remotely control the Bluetooth camera 140 through the second Bluetooth headset 120, to be filmed along with the first user.

The second Bluetooth headset 120 includes a data transmitter that remotely controls operations of the Bluetooth camera 130, so that the Bluetooth camera 130 may be operated remotely through the data transmitter even when users are far from the Bluetooth camera 130.

The speech synthesizer 121 may include a digital signal processor (DSP).

The DSP is a microprocessor that not only removes unnecessary sounds but also corrects sound distortions, and synthesizes necessary information by performing processes, such as filtering, Fourier conversion, or the like. The DSP has a processing speed that is 40 times faster than a normal microprocessor.

The Bluetooth camera 130 includes a speech storage 131 that stores synthesized speech data received by the second Bluetooth headset 120, and an image storage 132 that stores captured images. The Bluetooth camera 130 may be operated manually by the second user holding the camera and communicating with the first user, or may be supported on a support, such as a tripod, to be remotely controlled through the data transmitter built in the second Bluetooth headset 120.

Once speech data transmitted and received between the first user and the second user are synthesized by the speech synthesizer 121 of the second Bluetooth headset 120, to be transmitted to the Bluetooth camera 130, the Bluetooth camera 130 stores the speech data synthesized by the speech synthesizer 121 in the speech storage 131, so that the stored speech data may be played after filming to enable speech data of the first user and the second user to be checked afterwards.

As the Bluetooth camera 130 includes the image storage 132 that stores captured images, by operating the image storage 132 and the speech storage 131 together, filmed videos and speech data of the first user and the second user may be played together.

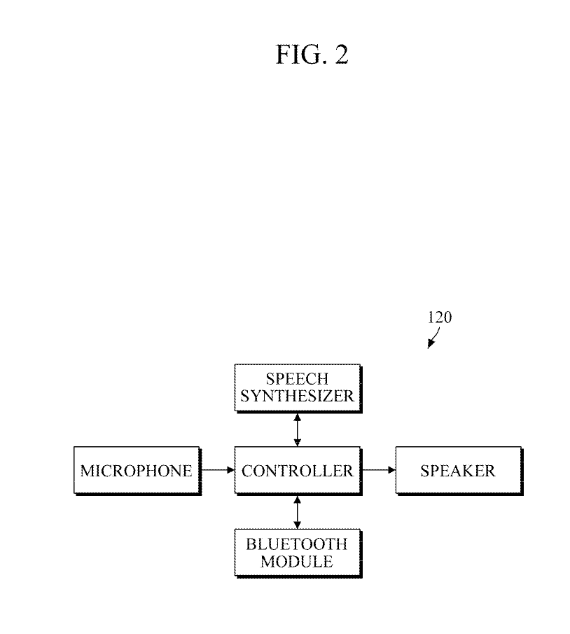

FIG. 2 is a block diagram illustrating a second Bluetooth headset in FIG. 1.

By referring to FIGS. 1 and 2, operations of the remote audio recording camera system 100 will be described below.

Once the second Bluetooth headset 120 receives speech data of the first user through a Bluetooth module, a controller receives speech data of the second user that has been received from a microphone to transmit speech data of the first user and speech data of the second user to the speech synthesizer 121. Then, the speech synthesizer 121 synthesizes speech data of the first user and speech data of the second user through a digital signal processor, to transmit the synthesized speech data to the controller.

Subsequently, the controller transmits the synthesized speech data to the Bluetooth module, and the Bluetooth module transmits the data to the Bluetooth camera 130. As the Bluetooth module includes a speech transmitter, speech data of the first user may be received to be heard through a speaker, and the synthesized speech data may be transmitted to the Bluetooth camera 130.

Accordingly, the Bluetooth camera 130 may receive the synthesized speech data to store the data in the speech storage 131, and by operating the image storage 132 and the speech storage 1431 together, the Bluetooth camera 130 may play a filmed video along with speech data of users.

As described above, the remote audio recording camera system 100 enables users to communicate with each other through Bluetooth headsets even when they are far from each other, thereby facilitating communication between users while filming.

In a conventional camera system, there is a problem in that speech of users may not be recorded in a camera. However, in the present disclosure, speech of users may be synthesized by the speech synthesizer 121 to be stored in the Bluetooth camera 130, such that speech of users may be recorded remotely.

Further, the second Bluetooth headset 120 includes a data transmitter to remotely control the Bluetooth camera 130, such that the Bluetooth camera 130 may be operated remotely through the data transmitter even when users are far from the Bluetooth camera 130 when filming.

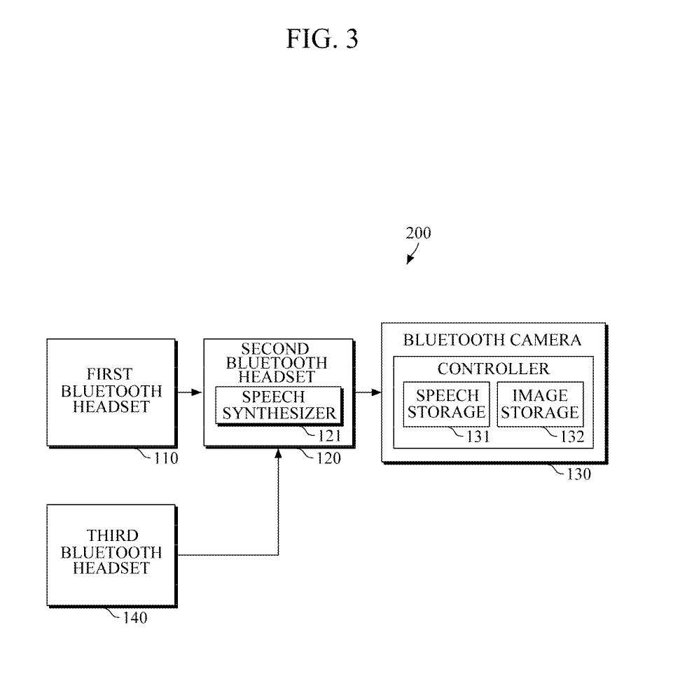

FIG. 3 is a block diagram illustrating another example of the remote audio recording camera system in FIG. 1.

As illustrated in FIG. 3, a remote audio recording camera system 200 further includes a third Bluetooth headset 140 to be worn by a third user that communicates with the second user, and the second Bluetooth headset 120 synthesizes speech data of the third user received by the third Bluetooth headset 140 and the synthesized speech data described above by using a speech synthesizer, and transmits the data to the Bluetooth camera 130.

The Bluetooth camera 130 receives and stores the synthesized speech data from the second Bluetooth headset 120, such that speech data of all the first, second, and third users may be checked through the Bluetooth camera 130.

As the third Bluetooth headset 140 that communicates with the second Bluetooth headset 120 is further included, direct communicate may be enabled between the second user and a plurality of users. That is, the second user may hear speech of the first user and the third user and may respond to them, thereby facilitating communication while filming. The second user wearing the second Bluetooth headset 120 may be a person that films a video, and the first user and the third user wearing the first Bluetooth headset 110 and the third Bluetooth headset 140 respectively may be subjects to be filmed.

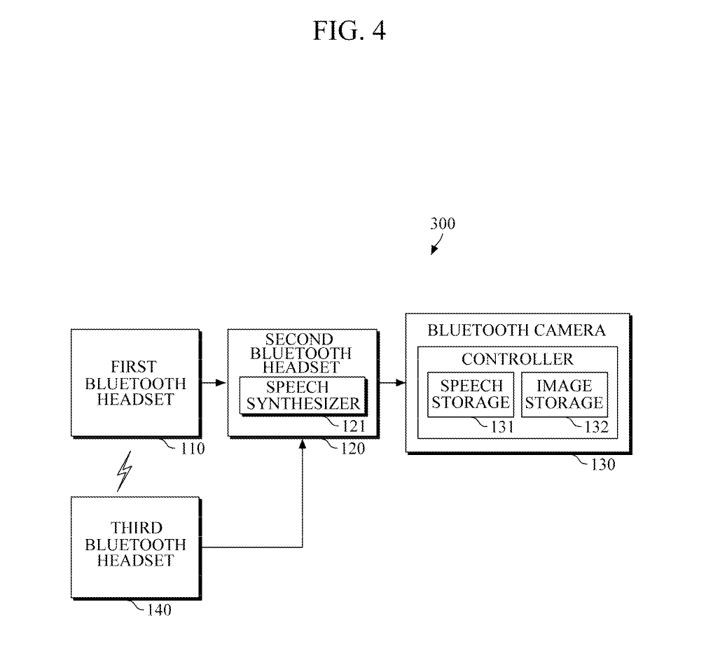

FIG. 4 is a block diagram illustrating another example of the remote audio recording camera system in FIG. 3.

As illustrated in FIG. 4, a remote audio recording camera system 300 enables the first user wearing the first Bluetooth headset 110 and the third user wearing the third Bluetooth headset 140 to communicate with each other.

Speech data of the first user received by the first Bluetooth headset 110, speech data of the third user received by the third Bluetooth headset 140, and speech data input from the second user are synthesized by the speech synthesizer 121, to be stored in the speech storage 131 of the Bluetooth camera 130, thereby enabling speech data transmitted and received between the users to be checked after filming.

As described above, the first user and the third user may directly communicate with each other, such that there is no need for the second user to relay communications between the first user and the third user.

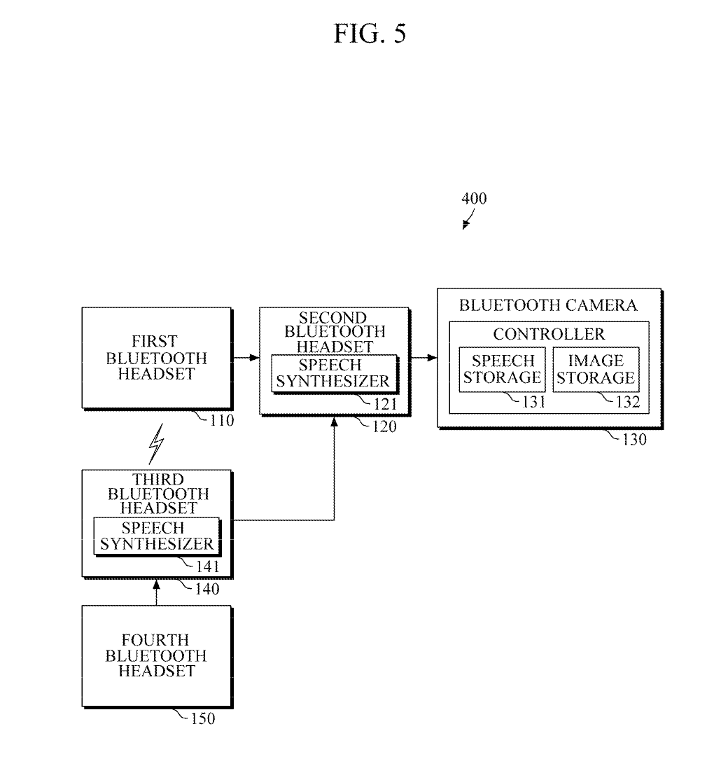

FIG. 5 is a block diagram illustrating another example of the remote audio recording camera system in FIG. 4.

As illustrated in FIG. 5, a remote audio recording camera system 400 may further include a speech synthesizer 141 of the third Bluetooth headset 140, and a fourth Bluetooth headset 150 worn by a fourth user that communicates with the third user.

The third Bluetooth headset 130 synthesizes speech data of the fourth user received by the fourth Bluetooth headset 150 and speech data input from the third user by using the speech synthesizer 141, and transmits the synthesized speech data to the second Bluetooth headset 120.

Subsequently, the second Bluetooth headset 120 synthesizes speech data of the first user received from the first Bluetooth headset 110, speech data input from the second user, and synthesized speech data of the third and fourth users received from the third Bluetooth headset 140 by using the speech synthesizer 121, and transmits the synthesized speech data to the

Bluetooth camera 130.

As the remote audio recording camera system 400 includes the speech synthesizer 141 and the fourth Bluetooth headset 150, a greater number of users may communicate with each other, and their communications may be recorded and stored in the Bluetooth camera 130, thereby enabling speech data to be checked after filming.

According to the present disclosure, even when users are far from each other, they may communicate with each other through a Bluetooth headset, thereby facilitating communication between users when filming.

Further, in a conventional camera system, there is a problem in that speech of users may not be recorded in a camera when the users are at a distance from the camera. However, the present disclosure synthesizes speech of users through a speech synthesizer, stores the synthesized speech in a speech storage of a Bluetooth camera, such that speech of users may be recorded remotely.

In addition, a third Bluetooth headset is further provided to enable a second user as a person who films videos to communicate with a first and a third users, thereby enabling direct communication between a person who is filming with a plurality of subjects to be filmed.

Moreover, a second Bluetooth headset is further provided with a data transmitter to remotely control operations of a Bluetooth camera, such that a Bluetooth camera may be operated remotely through the data transmitter even when the camera is at a distance from users while filming.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A remote audio recording camera system, comprising:
at least one first Bluetooth headset configured to be worn by a first user;
a second Bluetooth headset configured to be worn by a second user that communicates with the first user, and to synthesize speech data of the first user received by the first Bluetooth headset and speech data input from the second user by using a speech synthesizer to transmit the synthesized speech data; and
a Bluetooth camera configured to include a speech storage that stores the synthesized speech data received from the second Bluetooth headset, and an image storage that stores captured images.

2. The system of claim 1, further comprising:
a third Bluetooth headset configured to be worn by a third user that communicates with the second user,
wherein the second Bluetooth headset synthesizes speech data of the third user received by the third Bluetooth headset and the synthesized speech data by using the speech synthesizer to transmit the data to the Bluetooth camera.

3. The system of claim 2, wherein the first user wearing the first Bluetooth headset and the third user wearing the third Bluetooth headset communicate with each other.

4. The system of claim 1, wherein the second Bluetooth headset further comprises a data transmitter to remotely control the Bluetooth camera.

5. The system of claim 2, wherein the second Bluetooth headset further comprises a data transmitter to remotely control the Bluetooth camera.
